(19) United States
(12) Patent Application Publication
(10) Pub. No.: US 2024/0204465 A1
(43) Pub. Date: Jun. 20, 2024

(54) JUMPER SYSTEMS AND METHODS

(71) Applicant: Salisbury Electrical Safety L.L.C., Fort Mill, SC (US)

(72) Inventors: Bharath Reddy GAYAM, Charlotte, NC (US); Prudhvi YARLAGADDA, Charlotte, NC (US); Rustin L. OWEN, Charlotte, NC (US); Raviteja TATA, Charlotte, NC (US)

(21) Appl. No.: 18/525,095

(22) Filed: Nov. 30, 2023

(30) Foreign Application Priority Data
Dec. 16, 2022 (IN) 202211072940

(51) Int. Cl. H01R 13/71; H01R 43/26

(52) U.S. Cl. CPC H01R 13/71; H01R 43/26

(57) ABSTRACT

Methods, apparatuses, systems, and/or the like are provided. An example system may include a container configured to operably engage with at least one electrically conductive element. The container may include at least one electrical contact, wherein the at least one electrical contact includes at least one recess. The container may also include a trigger mechanism configured to transition the at least one electrical contact between a non-conductive position and a conductive position. The trigger mechanism may include a first lever configured to move between an engaged position and a disengaged position with the at least one recess of the at least one electrical contact. The at least one electrical contact is in the conductive position when the first lever is in the disengaged position and the at least one electrical contact is in the non-conductive position when the first lever is in the engaged position.

### CROSS-REFERENCE TO RELATED DOCUMENTATION

This application claims priority pursuant to 35 U.S.C. 119(a) to Indian Application No. 202211072940, filed Dec. 16, 2022, which application is incorporated herein by reference in its entirety.

### TECHNICAL FIELD

The present disclosure relates generally to jumpers. In particular and in some examples, the disclosure relates to jumpers used in overhead electric lines as conductors for carrying current to bypass work areas where electrical equipment is faulty.

### BACKGROUND

In certain environments, it may be necessary to divert electrical current in a conduit to bypass certain conduit areas, such as those in need of repair, maintenance, upgrade, or any other areas where current cannot flow. For example, overhead electric lines may become damaged during a storm and subsequently require repair, which necessitates bypassing the damaged areas to give technicians safe access to repair the damaged areas while still allowing current to flow through the electric lines.

One system for bypassing the damaged areas is a jumper. A jumper is a conductor line that carries full line current and can be used to bypass certain areas of an electrical conduit by rerouting the current such that the current avoids certain areas of the electrical conduit, as previously described. A jumper may have at least one electrical contact that can be selectively connected and disconnected to respectively conduct or not conduct electricity through the jumper. In some embodiments, the at least one electrical contact may include a pair of electrical contacts that can be selectively connected and disconnected using one or more mechanisms controlled by a technician. During operation, a first electrical contact may be connected to a first element on the conduit while a second electrical contact is connected to a second element on the conduit, where the area of the conduit that needs to be accessed is located between the first and second elements of the conduit. The first and second electrical contacts may be electrically disconnected until the technician activates a trigger mechanism that connects them, causing the current to flow between the first and second electrical contacts and through the jumper such that the current avoids the area of the conduit that needs to be accessed.

However, jumpers may have high production costs, may be complicated to assemble, and may have components that are difficult to operate. One component of jumper systems in particular that may be difficult to operate is the mechanism (or mechanisms) that cause the electrical contacts to connect and disconnect (thereby causing the jumper system to fulfill its purpose of rerouting the current around certain areas, such as those in need of repair). If a technician cannot safely, easily, and efficiently operate the mechanism controlling connection between the jumper's electrical contact, it may lead to delays, deficiencies, and danger to the technician.

Through applied effort, ingenuity, and innovation, Applicant has solved problems relating to production, assembly, and operation of jumpers and their various components and others by developing solutions embodied in the present disclosure, which are described in detail below.

### SUMMARY

In general, embodiments of the present disclosure provide methods, apparatuses, systems, computing devices, computing entities, and/or the like.

According to various embodiments, there is provided a jumper system including a container configured to operably engage with at least one electrically conductive element, the container including: at least one electrical contact, wherein the at least one electrical contact includes at least one recess; and a trigger mechanism configured to transition the at least one electrical contact between a non-conductive position and a conductive position, wherein the trigger mechanism includes: a first lever configured to move between an engaged position and a disengaged position with the at least one recess of the at least one electrical contact, wherein the first lever is inserted into the at least one recess in the engaged position and not inserted into the at least one recess in the disengaged position, wherein the at least one electrical contact is in the conductive position when the first lever is in the disengaged position and wherein the at least one electrical contact is in the non-conductive position when the first lever is in the engaged position; and a second lever operably connected to the first lever and configured to move the first lever from the engaged position to the disengaged position when a triggering force is applied.

In some embodiments, the container further includes an internal conductive holder configured to be in electrical contact with at least one of the at least one electrical contact, the at least one electrically conductive element, and the first lever.

In some embodiments, the container includes a shape selected from a group consisting of cylindrical or tubular.

In some embodiments, the at least one electrical contact includes a first electrical contact and a second electrical contact and wherein, in an instance in which the at least one electrical contact is in the conductive position, the first and the second electrical contacts conduct electricity received from the at least one electrically conductive element.

In some embodiments, the first electrical contact is fixedly attached to the container and the second electrical contact is at least partially disposed within the container and configured to move with respect to the first electrical contact.

In some embodiments, the at least one recess is a rectangular notch and the first lever is a rectangular shape, and wherein the recess and the first lever are orthogonal to each other when the first lever is in the engaged position.

In some embodiments, the at least one recess includes a first recess and the at least one electrical contact further includes a second recess, and wherein the first recess and the second recess are disposed on opposed sides of the at least one electrical.

In some embodiments, the trigger mechanism further includes a trigger spring configured to operably engage the second lever and prevent the second lever from moving the first lever between the engaged position and the disengaged position until the triggering force is applied.

In some embodiments, the at least one electrically conductive element includes a first element includes a power line and a second element includes a conductor bar, wherein the conductor bar is not in direct electrical contact with the power line.

In some embodiments, the at least one electrically conductive element includes a first part of a power line and a second part of the power line.

In some embodiments, the container includes nylon.

In some embodiments, the at least one electrical contact is aluminum.

In some embodiments, wherein the at least one electrically conductive element includes a conductor holder.

In some embodiments, the conductor holder is composed of an aluminum alloy.

In some embodiments, the trigger mechanism further includes a housing, and wherein the first and second levers are at least partially disposed within the housing.

In some embodiments, the housing includes a rectangular shape.

In some embodiments, the jumper further includes a reset mechanism configured to transition the at least one electrical contact between a conductive position and a non-conductive position, wherein the reset mechanism includes: a reset spring operably engaged with the at least one electrical contact and configured to move between a compressed state and an extended state, wherein the at least one electrical contact are in the conductive position when the spring is in the extended state and the at least one electrical contact is in the non-conductive position when the spring is in the compressed state; an actuator configured to move the spring between the extended state and the compressed state when a resetting force is applied.

In some embodiments, the reset mechanism further includes one or more supports configured to retain the spring in the compressed state until the triggering force is applied.

In some embodiments, the actuator is ring-shaped and fixedly attached to the at least one electrical contact.

According to various embodiments, there is provided a method of using a jumper system, wherein the jumper system includes a container configured to operably engage with at least one electrically conductive element, the container including: at least one electrical contact, wherein the at least one electrical contact includes at least one recess; a trigger mechanism configured to transition the at least one electrical contact between a non-conductive position and a conductive position, wherein the trigger mechanism includes: a first lever configured to move between an engaged position and a disengaged position with the at least one recess of the at least one electrical contact, wherein the at least one electrical contact is in the conductive position when the first lever is in the disengaged position and wherein the at least one electrical contact is in the non-conductive position when the first lever is in the engaged position; and a second lever operably connected to the first lever and configured to move the first lever from the engaged position to the disengaged position when a triggering force is applied; and a reset mechanism configured to transition the at least one electrical contact between a conductive position and a non-conductive position, wherein the reset mechanism includes: a reset spring operably engaged with the at least one electrical contact and configured to move between a compressed state and an extended state, wherein at least one electrical contact is in the conductive position when the spring is in the extended state and at least one electrical contact is in the non-conductive position when the spring is in the compressed state; an actuator configured to move the spring between the extended state and the compressed state when a triggering force is applied, wherein the method includes: applying the triggering force to the second lever to move the first lever between the engaged position and the disengaged position; and applying the resetting force to the actuator to move the spring between the extended state and the compressed state.

The above summary is provided merely for purposes of summarizing some example aspects to provide a basic understanding of some aspects of the disclosure. Accordingly, it will be appreciated that the above-described aspects are merely examples. It will be appreciated that the scope of the disclosure encompasses many potential aspects in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1A is an elevation, side, cutaway view of an example jumper system in accordance with various embodiments of the present disclosure;

FIG. 1B is an angled, exploded view of an example trigger mechanism in accordance with various embodiments of the present disclosure;

FIG. 2A is an elevation, side, cutaway view of an example jumper system in a non-conductive position in accordance with various embodiments of the present disclosure;

FIG. 2B is an elevation, side, cutaway view of an example jumper system in a conductive position in accordance with various embodiments of the present disclosure;

FIG. 3A is an elevation, side view of an example jumper system in a non-conductive position in accordance with various embodiments of the present disclosure;

FIG. 3B is an elevation, side, cutaway view of an example jumper system in a conductive position in accordance with various embodiments of the present disclosure; and

FIG. 4 is a flow chart showing an example method of using an example jumper system in accordance with various embodiments of the present disclosure.

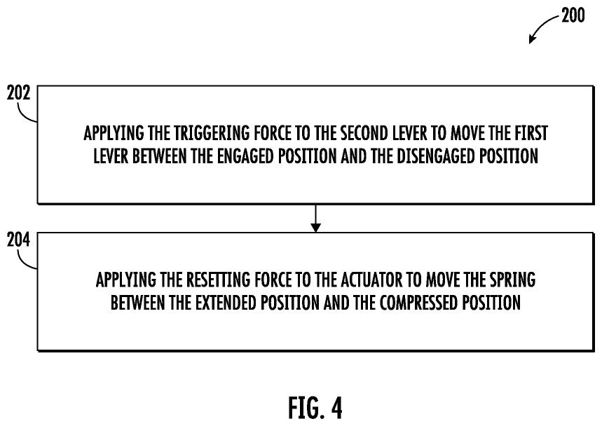

### DETAILED DESCRIPTION OF SOME EXAMPLE ASPECTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these aspects are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one aspect of the present disclosure and may be included in more than one aspect of the present disclosure (importantly, such phrases do not necessarily may refer to the same aspect).

### Overview

A jumper, in some examples, is a conductor line that carries full line current and can be used to bypass certain areas of an electrical conduit by rerouting the current such that the current avoids these certain areas of the electrical conduit. A jumper may have at least one electrical contact that can be selectively connected and disconnected to conduct electricity from the electrical conduit through the jumper. In some embodiments, the at least one electrical contact may include a pair of electrical contacts that can be selectively connected and disconnected by a technician. In some embodiments, the jumper may also include one or more spring contacts that may facilitate a connection between the first and second contacts by eliminating clearance between the first and second contacts, or between the first and second contacts and other components of the jumper. During operation, a first electrical contact may be connected to a first element on the conduit while the second electrical contact is connected to a second element on the conduit, where the area of the conduit that needs to be accessed is located between the first and second elements of the conduit. For example, the first contact of the jumper may be connected to one location on a power line that has been damaged, and the second contact of the jumper may be connected (e.g., by a cable) to a second location on the damaged power line. In an instance in which the technician activates a trigger mechanism that connects the first and second elements of the conduit, the current flows between the first and second electrical contacts and through the jumper such that the current avoids the area of the conduit that needs to be accessed and through which electricity cannot flow.

In some examples, the jumper may also have a reset mechanism that the technician activates to disconnect the first and second electrical contacts such that current does not flow between them. Once the damaged area has been repaired, the jumper may be removed from the first and second elements on the conduit (after the conduit has been deenergized) and then the reset mechanism may be triggered. When the reset mechanism is triggered, the jumper is no longer configured to reroute current around the area that needs to be accessed. The jumper may then be reused for rerouting current through other conduits or around different areas of the same conduit as needed.

The jumper may include, in some examples, the trigger mechanism and the reset mechanism, each of which may include additional components. For example, the jumper may have a container in which the first and second electrical contacts are at least partially disposed. The jumper may also have an internal conductive element within the container that electrically connects one or more of the first contact, the second contact, at least one component of the trigger mechanism, and at least one of the first and second elements of the conduit. As another example, the trigger mechanism may be operated by one or more operably connected levers and a trigger spring or similar tensioning mechanism. As a further example, the reset mechanism may operate according to an actuator and a resetting spring. The trigger and reset mechanism may be operated by technicians using non-conductive tools to transition the jumper from conductive to non-conductive positions (and vice-versa).

The example jumper system and its various components (including the trigger and reset mechanism) will now be described in greater detail.

### Example Jumper Systems

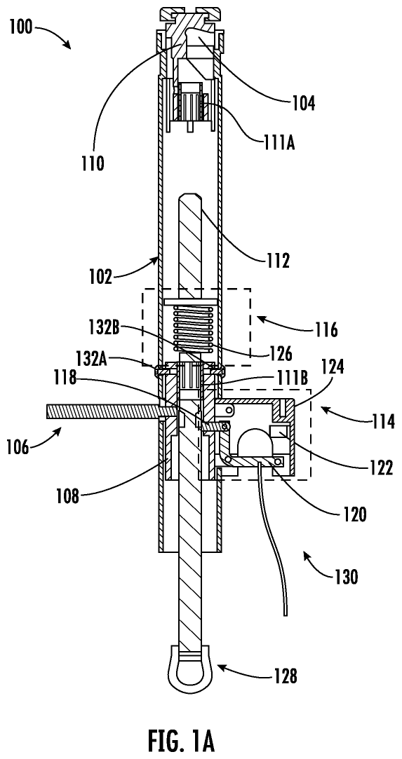

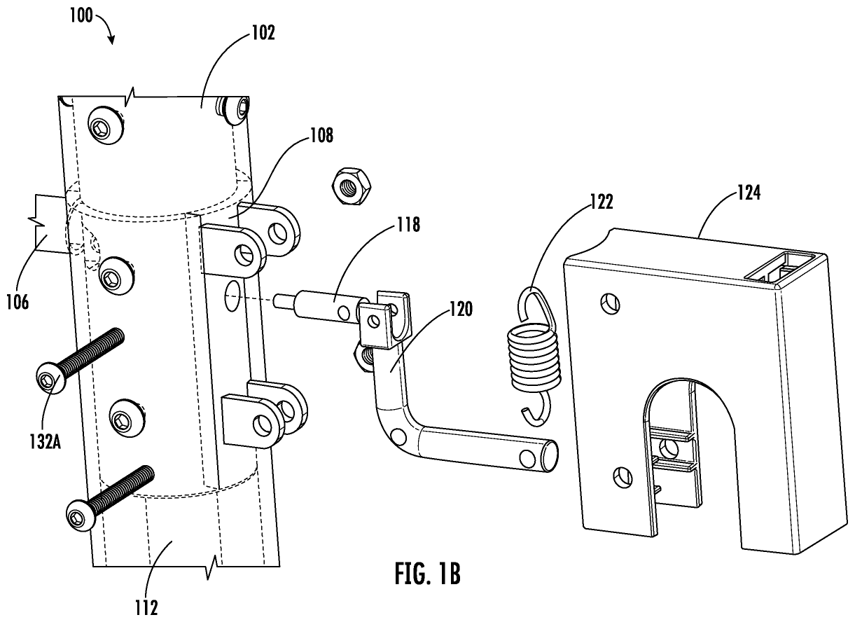

As shown in FIG. 1A-3B, a jumper system 100 may include a container 102 that is configured to engage with at least one electrically conductive element. In some embodiments, the container 102 may be an elongated, hollow body configured to hold various components and operably connected to various mechanisms. In some embodiments, the container 102 may be a non-conductive material, such as plastic. In some embodiments, the container 102 may be made of electrically insulative plastics, such as nylon, polybutylene terephthalate (PBT), or polyvinyl chloride (PVC). In some embodiments, the container 102 may be in cylindrical or tubular in shape.

In some embodiments, an electrical conduit (such as a power line) may be operably connected to the container 102 by at least one electrically conductive element. In some embodiments, the at least one electrically conductive element may include a first electrically conductive element 104. In some embodiments, the first electrically conductive element 104 may be a conductor holder. For example, the electrical conduit may be a power line that is connected to the conductor holder. In some embodiments, the conductor holder may be operably attached to the container 102, while in other embodiments the conductor holder may be fixedly attached or integrated with the container 102 (as shown in at least FIG. 1A). In some embodiments, the conductor holder may be operably connected to a part of a conductor, such as a power line.

In some embodiments, the at least one electrically conductive element of the jumper system 100 may include a second electrically conductive element 106 that is operably engaged with the container 102 and configured to connect to a conduit (e.g., a power line). In some embodiments, the second electrically conductive element 106 may be a conductor bar that may be connected to a conduit, such as a power line. In some embodiments, the second electrically conductive element 106 may be a part of the conduit (e.g., a part the power line). In some embodiments, one or more electrically cables (or other connecting elements) may be connected to the electrically conductive element 106 and the one or more cables may be connected to the electrical conduit (e.g., to a power line).

In some embodiments, the first electrically conductive element 104 may be disposed on a side surface of the container 102 and the second electrically conductive element 106 may be disposed on the top of the container 102, while in other embodiments these positions may be reversed, or each element 104, 106 may be disposed on the same surface. In other embodiments, there may be more than two electrically conductive elements (e.g., a third, fourth, fifth, etc. electrically conductive elements) that are disposed on various locations on the container 102.

In some embodiments, the container 102 may include an internal conductive holder 108 that may be disposed inside the container 102. In some embodiments, the internal conductive holder 108 may be metal, such as aluminum or copper. In some embodiments, the internal conductive holder 108 may be substantially the same type of shape as the container 102 (e.g., if the container is cylindrical, the internal conductive holder 108 is cylindrical). In some embodiments, the conductive holder 108 may be snug fit within the container 102, while in other embodiments the conductive holder 108 may be operably or fixedly attached to the container 102 by various fastening mechanisms, such as screws. For example, the internal conductive holder 108 may be fixedly attached to the container 102 by one or more fasteners 132A, 132B. In some examples, the container 102 and the internal conductive holder 108 may not be electrically conductive at least because the container is made of non-conductive material. In some embodiments, as will be described in greater detail later in this disclosure, the internal conductive holder 108 may be electrically connected to one or more components of the container 102 and/or one or more components connected to the container 102.

In some embodiments, the jumper system 100 may include one or more electrical contacts, including a first electrical contact 110 and a second electrical contact 112. In some embodiments, one of the electrical contacts (e.g., the first 110) may be fixedly attached to the container 102, while the other electrical contact (e.g., the second 112) may be configured to move with respect to the container and/or the other, fixed electrical contact. In some embodiments, the first electrical contact 110 may be the contact that is fixedly attached and the second electrical contact 112 may be the contact that is configured to move with respect to the container. However, in other embodiments, the first and second electrical contacts 110, 112 may be reversed (i.e., the second is fixed and the first is configured to move). In still other embodiments, the first and second electrical contacts 110, 112 may each be fixed or each configured to move. In some embodiments, the first and second electrical contacts 110, 112 may be made of conductive material, such as a metal (e.g., aluminum or copper).

In some embodiments, one or both of the first or second electrical contacts 110, 112 may be in electrical contact with one or more of the at least one electrically conductive elements (e.g., first element 104 or second element 106). As shown in FIG. 1A, the first electrical contact 110 may be in electrical contact with the first element 104, while the second electrical contact 112 may be in electrical contact with the second element 106. However, multiple variations of connection between the first and second electrical contacts and the at least one electrically conductive elements may be possible.

In some embodiments, the one or more electrical contacts may include one or more spring contacts 111A, 111B. In some embodiments, the spring contacts 111A, 111B may be sheaths configured to be wrapped partially or wholly around one or more of the first or second electrical contacts 110, 112. In some embodiments, a first spring contact 111A may be encased around the first electrical contact 110 and a second spring contact 111B may be encased around the second electrical contact 112. In some embodiments, the spring contacts 111A, 111B may be conductive, metal material, and the spring contacts 111A, 111B may be flexible. In some embodiments, the spring contacts 111A, 111B may be configured to eliminate clearance (e.g., air or vacuum gaps) between the first and second contacts 111A, 111B when the first and second contacts 110, 112 are brought into conductive contact with one another. That is, in some embodiments (absent the spring contacts 111A, 111B) there may be a gap between the first and second contacts 110, 112 that prevents current from flowing between the first and second contacts 110, 112. In some embodiments, there may be a gap (absent the spring contacts 111A, 111B) between either the first or second contact 110, 112 that prevents current from flowing between the contacts 110, 112 and other components of the system 100, such as the internal conductive holder 108. The spring contacts 111A, 111B are configured to eliminate such gaps within the system 100 and ensure contact between various components of the system 100.

In some embodiments, the at least one electrical contact may be in conductive contact with the internal conductive holder 108. In some embodiments, where the at least one electrical contact includes a first and second electrical contact, one or both of the first or second electrical contacts 110, 112 may be in conductive contact with the internal conductive holder 108. As shown in FIG. 1A, the second electrical contact 112 may be connected to the internal conductive holder 108 by the second spring contact 111B such that current flows between the internal conductive holder 108 and the second contact 112. In some embodiments, the spring contact 111A may be configured to eliminate clearance between the first and second electrical contacts 110, 112, as previously described.

In some embodiments, the at least one electrical contact may either be in a conductive position or a non-conductive position. In some embodiments, where the at least one electrical contact includes first and second electrical contacts 110, 112, the first and second electrical contacts 110, 112 may either be in a conductive position or a non-conductive position. In both the conductive and non-conductive positions, the contacts 110, 112 are each at least partially disposed within the container 102. For example, as shown in at least FIG. 1A, the second contact 112 is partially disposed within the container 102, while the first contact 110 is fully disposed within the container 102.

In a non-conductive position, the first and second contacts 110, 112 are configured such that electricity may not conductively pass between them (e.g., they are separated by some substantially non-conductive distance within the container 102, such as air or void). FIGS. 1A, 2A, and 3A show the first and second contacts 110, 112 in a non-conductive position, according to various embodiments.

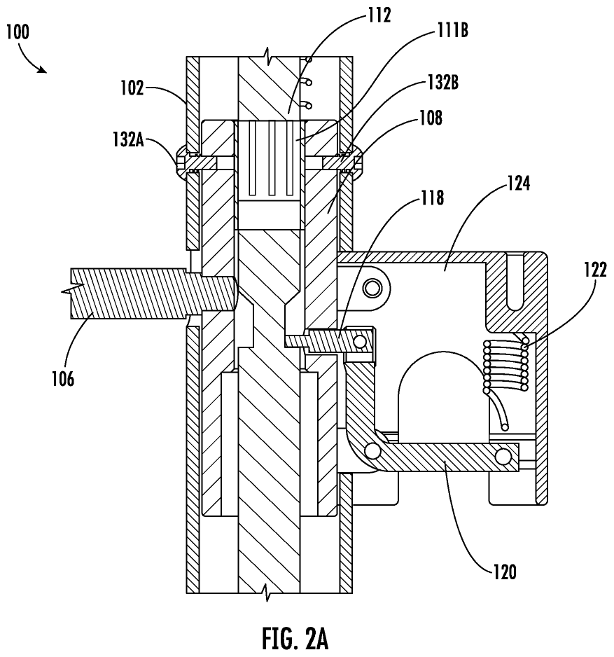

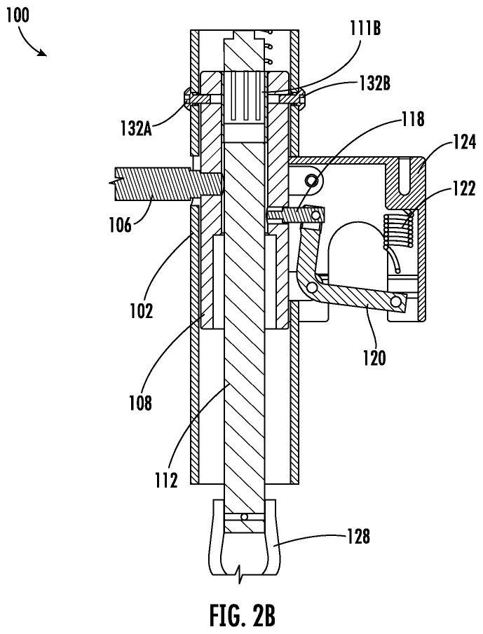

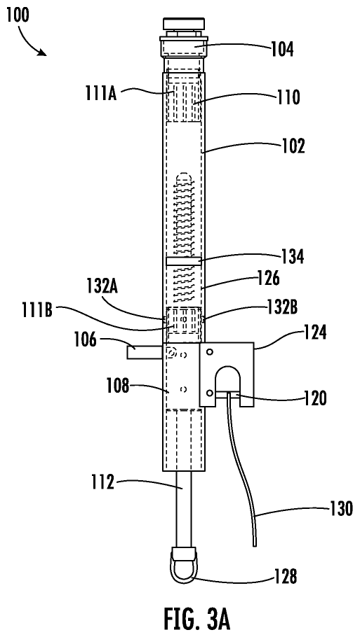

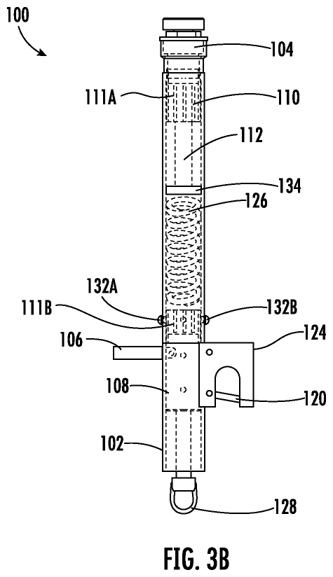

In a conductive position, as shown in at least FIGS. 2B and 3B, the first and second contacts 110, 112 are connected to each other such that electricity may flow between them. In the conductive position, in some embodiments, the first and second contacts 110, 112 are electrically connected to each other and to the at least one electrically conductive element, such that electricity may then flow from the at least one electrically conductive element through the first and second contacts 110, 112. If there are two electrically conductive elements (e.g., 104 and 106), and if one contact is connected to one electrically conductive element and the other contact is connected to the other electrically conductive then when the first and second contacts 110, 112 are in the conductive position, electricity may flow between the two electrically conductive elements by flowing through the first and second contacts 110, 112. In some embodiments, the spring contact 111A may facilitate electrical conductivity between the first and second electrical contacts 110, 112 when the first and second electrical contacts are in the conductive position.

According to various embodiments, and as shown in an exploded view in FIG. 1B, a trigger mechanism 114 may be configured to move the first and second contacts 110, 112 between a non-conductive position and a conductive position and a reset mechanism 116 may be configured to move the first and second contacts 110, 112 between a conductive position and a non-conductive position.

As shown in FIG. 1A, the jumper system 100 may include a trigger mechanism 114 and a reset mechanism 116. In some embodiments, the trigger mechanism 114 may include a first lever 118, a second lever 120, and a trigger spring 122. In some embodiments, the trigger mechanism 114 may include a housing 124 in which the other components of the trigger mechanism 114 are wholly or partially disposed. In some embodiments, the housing 124 may be rectangularly shaped. In some embodiments, the housing 114 may have one or more openings, which may provide access to the levers 118, 120, or allow the levers 118, 120 to access various components of the system 100.

In some embodiments, and as shown in at least FIGS. 1A and 2A, the first lever 118 may be operably engaged with one of the contacts 110, 112 to keep the contacts 110, 112 in the non-conductive position. In some embodiments, and as shown in FIGS. 1A and 2A, the first lever 118 may be in an engaged position wherein the first lever 118 is inserted into a recess (such as a notch, which may be rectangular) of the at least one electrical contact. In some embodiments, the at least one electrical contact having the recess may be the second electrical contact 112. In some embodiments, when the first lever 118 is inserted into the recess it will prevent the second electrical contact 112 from moving into contact with the first electrical contact 110. In some embodiments, the first lever 118 may be orthogonal to the recess when the first lever 118 is inserted into the recess (i.e., when the first lever 118 is in the engaged position). Subsequently, in some embodiments, and as shown in at least FIG. 2B, the first lever 118 may be moved into a disengaged position by removing the first lever 118 from the recess of the second electrical contact 112, which may cause the second electrical contact 112 to move into contact with the first electrical contact 110.

In some embodiments, first and second levers 118, 120 may be operably engaged such that moving the second lever 120 may move the first 118. For example, the first and second levers 118, 120 may be mechanically linked such that pulling the second lever 120 in a first direction causes the first lever 118 to translate in a second direction. In some embodiments, the first and second directions may be orthogonal to each other. In some embodiments, the second lever 120 may be pulled (e.g., by a technician using a non-conductive grasping mechanism 130, such as a lanyard) or otherwise urged in a direction parallel to the length of the container 102 and thereby move the first lever 118 in a direction perpendicular to the length of the container 102, subsequently releasing the second contact 112 and causing it to move into contact with the first contact 110, thereby moving the first and second contacts 110, 112 into the conductive position. In some embodiments, the force required to move the first lever may be in the range of 60 Newtons to 125 Newtons of force.

In some embodiments, the trigger spring 122 may be an extended spring configured to operably engage the second lever 120 and apply a force against the second lever 120 to prevent it from moving the first lever 118 between the engaged and the disengaged positions. In some embodiments, the trigger spring 122 may press a portion of the second lever 120 against the housing 124, keeping the second lever 120 substantially rigid and the first lever in the engaged position. In some embodiments, the force required to move the first lever from the engaged position to the disengaged position may be greater than the spring force of the trigger spring 122.

As shown in FIGS. 1A, 3A, and 3B, the reset mechanism 116 may include a reset spring 126 and an actuator 128. In some embodiments, the reset spring 126 may be a compressed spring operably engaged with the second contact 112. In some embodiments, the reset spring 126 may extend as the second contact 112 moves from the non-conductive position to the conductive position (i.e., as the second contact 112 moves from being not electrically conductive with the first contact 110 to being electrically conductive with the first contact 110). In some embodiments, a support 134 may be disposed within the container 102 and operably connected to the reset spring 126 and/or the second contact 112. In some embodiments, one or more supports 134 may be made of a non-conductive material, such as plastic. In some embodiments, the supports 134 may be plastic. In some embodiments, the supports 134 may be configured to retain the reset spring 126 such that the reset spring 126 remains in the compressed state.

In some embodiments, the actuator 128 may be configured to move or otherwise urge the reset spring 126 from an extended state (that is, when the first and second contacts 110, 112 are in the conductive position) to a compressed state (that is, when the first and second contacts 110, 112 are in the non-conductive position). In some embodiments, the actuator 128 may be ring-shaped and fixedly attached to the second contact 112, as shown in FIG. 1A. In some embodiments, the actuator 128 may move the reset spring 126 by applying a resetting force that pulls the spring from the extended state to the compressed state. In some embodiments, this resetting force may be applied when a technician pulls on the ring-shaped actuator 128 (e.g., by using a non-conductive device with a hook-shaped ending for gripping the reset ring). It is important to note that resetting occurs after the jumper system 100 has been removed from the electrically conductive elements; that is, the system 100 should be deenergized and removed from connection with the electrically conductive elements before the technician applies the resetting force by the reset spring 126. Failure to first de-energize the system 100 and/or the conduit before removing the system 100 from the conduit may cause hazards, such as arc flash.

In some embodiments, the mechanisms 114 and 116 may be operably connected to one or more of the container 102, the internal conductive holder 108, and the electrical contacts 110, 112. In some embodiments, the mechanisms 114, 116 may be fixedly attached to and/or disposed within the container 102. For example, the trigger mechanism 114 is shown to have been fixedly attached to the internal conductive holder 108 (e.g., by fasteners, such as screws), and the reset mechanism 116 is shown to be operably engaged with the second contact 112.

### Example Methods of Use for Example Jumper Systems

Example methods, such as method 200, of using the jumper system 100 and its various components and mechanisms will now be described. with reference to the systems, apparatuses, and components described with respect to FIGS. 1A, 1B, 2A, 2B, 3A, and 3B. However, it will be understood that these methods (e.g., 200) may be performed with respect to a variety suitable systems, devices, and components.

In some embodiments, a method 200 may be provided for using a jumper system (such as jumper system 100, as previously described). In some embodiments, the method 200 may include a step 202 of applying the triggering force to the second lever to move the first lever between the engaged position and the disengaged position (thereby moving the first and second contacts into the conductive position). In some embodiments, the method 200 may include a step 204 of applying the resetting force to the actuator to move the spring between the extended state and the compressed state (thereby moving the first and second contacts into the non-conductive position). These steps may be performed both when the jumper system is and is not connected to an electrical conduit. When connected to a jumper, the method may include an intervening step of de-energizing the conduit and disconnecting the jumper system from the conduit before applying the resetting force. In some embodiments, these steps may be repeated as necessary to connect and disconnect a jumper system from an electrical conduit in a variety of situations. For example, a jumper may be attached to a conduit (e.g., to bypass a work area), a triggering force may be applied by a technician, the electricity may then bypass the work area, and the work may commence on the work area; then, once the work is completed, the technician may deenergize the conduit, detach the jumper from the conduit, and then apply the resetting force so that the first and second contacts of the jumper are no longer configured to conduct electricity, and the jumper may be used for a different purpose (e.g., another damaged power line).

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

What is claimed is:

1. A jumper system comprising:
a container configured to operably engage with at least one electrically conductive element, the container comprising:
at least one electrical contact, wherein the at least one electrical contact comprises at least one recess;
a trigger mechanism configured to transition the at least one electrical contact between a non-conductive position and a conductive position, wherein the trigger mechanism comprises:
a first lever configured to move between an engaged position and a disengaged position with the at least one recess of the at least one electrical contact, wherein the first lever is inserted into the at least one recess of the at least one electrical contact when the first lever is in the engaged position and the first lever is not inserted into the at least one recess when the first lever is in the disengaged position,
wherein the at least one electrical contact is in the conductive position when the first lever is in the disengaged position and wherein the at least one electrical contact is in the non-conductive position when the first lever is in the engaged position; and
a second lever operably connected to the first lever and configured to move the first lever from the engaged position to the disengaged position when a triggering force is applied.

2. The jumper system of claim 1, wherein the container further comprises an internal conductive holder configured to be in electrical contact with at least one of the at least one electrical contact, the at least one electrically conductive element, and the first lever.

3. The jumper system of claim 1, wherein the container comprises a shape selected from a group consisting of cylindrical or tubular.

4. The jumper system of claim 1, wherein the at least one electrical contact comprises a first electrical contact and a second electrical contact and wherein, in an instance in which the at least one electrical contact is in the conductive position, the first and the second electrical contacts conduct electricity received from the at least one electrically conductive element.

5. The jumper system of claim 4, wherein the first electrical contact is fixedly attached to the container and the second electrical contact is at least partially disposed within the container and configured to move with respect to the first electrical contact.

6. The jumper system of claim 1, wherein the at least one recess comprises a rectangular notch and the first lever comprises a rectangular shape, and wherein the rectangular notch and the first lever are orthogonal to each other at least when the first lever is in the engaged position.

7. The jumper system of claim 1, wherein the at least one recess comprises a first recess and wherein the at least one electrical contact further comprises a second recess, and wherein the first recess and the second recess are disposed on opposed sides of the at least one electrical contact.

8. The jumper system of claim 1, wherein the trigger mechanism further comprises a trigger spring configured to operably engage the second lever and prevent the second lever from moving the first lever between the engaged position and the disengaged position until the triggering force is applied.

9. The jumper system of claim 1, wherein the at least one electrically conductive element comprises a first element comprised of a power line and a second element comprised of a conductor bar, wherein the conductor bar is not in direct electrical contact with the power line.

10. The jumper system of claim 1, wherein the at least one electrically conductive element comprises a first element comprised of a first part of a power line and a second element comprised of a second part of the power line.

11. The jumper system of claim 1, wherein the container comprises nylon.

12. The jumper system of claim 1, wherein the at least one electrical contact comprises aluminum.

13. The jumper system of claim 1, wherein the at least one electrically conductive element comprises a conductor holder.

14. The jumper system of claim 13, wherein the conductor holder comprises an aluminum alloy.

15. The jumper system of claim 1, wherein the trigger mechanism further comprises a housing, and wherein the first and second levers are at least partially disposed within the housing.

16. The jumper system of claim 15, wherein the housing comprises a rectangular shape.

17. The jumper system of claim 1, further comprising a reset mechanism configured to transition the at least one electrical contact between a conductive position and a non-conductive position, wherein the reset mechanism comprises:
a reset spring operably engaged with the at least one electrical contact and configured to move between a compressed state and an extended state,
wherein the at least one electrical contact is in the conductive position when the reset spring is in the extended state and the at least one electrical contact is in the non-conductive position when the reset spring is in the compressed state;
an actuator configured to move the reset spring between the extended state and the compressed state when a resetting force is applied.

18. The jumper system of claim 17, wherein the reset mechanism further comprises one or more supports configured to retain the spring in the compressed state until the triggering force is applied.

19. The jumper system of claim 18, wherein the actuator is ring-shaped and fixedly attached to the at least one electrical contact.

20. A method of using a jumper system, wherein the jumper system comprises
a container configured to operably engage with at least one electrically conductive element, the container comprising:
at least one electrical contact, wherein the at least one electrical contact comprises at least one recess;
a trigger mechanism configured to transition the at least one electrical contact between a non-conductive position and a conductive position, wherein the trigger mechanism comprises:
a first lever configured to move between an engaged position and a disengaged position with the at least one recess of the second electrical contact,
wherein the at least one electrical contact is in the conductive position when the first lever is in the disengaged position and wherein the at least one electrical contact are in the non-conductive position when the first lever is in the engaged position; and
a second lever operably connected to the first lever and configured to move the first lever from the engaged position to the disengaged position when a triggering force is applied; and
a reset mechanism configured to transition the at least one electrical contact between a conductive position and a non-conductive position, wherein the reset mechanism comprises:
a spring operably engaged with the at least one electrical contact and configured to move between a compressed state and an extended state,
wherein the at least one electrical contact is in the conductive position when the spring is in the extended state and the at least one electrical contact is in the non-conductive position when the spring is in the compressed state;
an actuator configured to move the spring between the extended state and the compressed state when a resetting force is applied,
wherein the method comprises:
applying the triggering force to the second lever to move the first lever between the engaged position and the disengaged position; and
applying the resetting force to the actuator to move the spring between the extended state and the compressed state.
